(19) United States
(12) Patent Application Publication
(10) Pub. No.: US 2003/0212627 A1
(43) Pub. Date: Nov. 13, 2003

(54) System and method for auctioning bids on construction projects

(76) Inventors: Wesley E. Burns, Kimberling City, MO (US); Blake H. Burns, Miami, FL (US); Charles R. Paris, Springfield, MO (US)

Correspondence Address: Richard C. Litman, LITMAN LAW OFFICES, LTD., P.O. Box 15035, Arlington, VA, 22215, US

(21) Appl. No.: 10/423,858

(22) Filed: Apr. 28, 2003

Related U.S. Application Data
(60) Provisional application No. 60/377,978, filed on May 7, 2002.

(51) Int. Cl. G06F 17/60

(52) U.S. Cl. 705/37

(57) ABSTRACT

A computerized system and method for auctioning bids on construction projects. The system utilizes Internet or intranet client-server technology.

### CROSS-REFERENCE TO RELATED APPLICATION

This application claims the benefit of U.S. Provisional Patent Application Serial No. 60/377,978, filed May 7, 2002.

### BACKGROUND OF THE INVENTION

1. Field of the Invention

The present invention relates to a multi-stage system and method for auctioning bids on construction projects. More particularly, the present invention relates to a multi-stage system and method for auctioning bids on available construction projects with a variety of participants.

2. Description of Related Art

The Internet has dramatically changed the way people do business. The Internet can be used as a central reference for people in a particular industry to use and access. The Internet can also be used as a resource tool for doing specific research. But probably the most popular use of the Internet is for generating new business for a particular business. Showcasing particular goods and services on the Internet is a very powerful business tool. Some clever businesspeople even use the Internet as an auctioning and bidding medium for products and services.

The particular use of the Internet as an auctioning and bidding medium is reflected in the related art. U.S. Pat. No. 5,794,219 issued to Brown, outlines a method of conducting an on-line auction that permits individual bidders to pool bids during a bidding session. The auction is conducted over a computer network that includes a central computer, a number of remote computers and communication lines connecting the remote computers to the central computer. A number of bidding groups are registered in the central computer, each bidding group having a total bid for the item being auctioned.

U.S. Pat. No. 5,950,206 issued to Krause, outlines the use of a method and an apparatus for searching for and tracking construction projects and includes a mass data storage device for storing a database of project information and document information related to construction projects. A member terminal includes a computer connected to an input device and a display device. A user enters the data for tracking based upon selection of at least one key word contained in the project information stored in the databases, using the input device to mark at least one construction project identification for tracking based upon the key word.

U.S. Pat. No. 5,920,849 issued to Broughton et al., outlines systems and methods which assist a contractor in producing a competitive bid proposal. In one exemplary embodiment, a method is provided for producing a bid from at least one drawing, including various items to be included in the bid. To produce the bid, the method relies upon a computer having a display screen, an entry device and a processor coupled to the display screen and entry device.

U.S. Pat. No. 6,021,398 issued to Ausubel, outlines a computer implemented system and method of executing an auction. The system has at least two intelligent systems, one for the auctioneer and at least one for a user. The auction is conducted by the auctioneer's system communicating with the user system. The auctioneer's system receives information from the user's system based on bid information entered by the user. With this information, the auctioneer's system determines whether the auction can be concluded or not, and appropriate messages are transmitted to the user.

U.S. Pat. No. 6,038,547 issued to Casto, outlines a computer-based tracking system and method for coordinating work done on a project and payment therefor. After a project has been partitioned by an architect, jobs are specified in terms of which region or subregion each entry corresponds. The contractors submit monthly application and certificate for payment requests, which are organized by the system to enable all the work in a particular region to be consolidated and listed on a reviewer's card for ease of verification.

U.S. Pat. No. 6,324,508 issued to Finney, outlines a method for performing a construction quantity takeoff estimate of a drawing representative of a construction project having a plurality of items that includes applying first vocal indicia representative of a selected item of the plurality of items to a voice recognition system and producing first electrical signals representative of the first vocal indicia by the voice recognition system. The selected item is first determined by the voice recognition system in accordance with the first electrical signals. Second vocal indicia representative of a quantity of the selected item are applied to the voice recognition system and second electrical systems representative of the quantity of the selected items that are produced.

U.S. Pat. No. 6,345,258 issued to Pickens, outlines an information system for the management of a new home construction process. The system is designed to be used by builders that reuse house plans or product information in the new homes they build. Three distinct steps in the process are used as the basis for the information model: product development, procurement and order fulfillment. The software is divided into three modules based upon three distinct dialects that must be related and communicated efficiently.

Although each of the previously described patents outline novel and useful inventions, what would really be useful is a system and method to implement an auction system to contract for the acquisition and procurement of construction services from qualified contractors through the use of the Internet, an intranet, enabling technology, and/or computer software product. That is what is needed in the marketplace, a system and method for auctioning bids on available construction projects with a variety of participants.

None of the above inventions and patents, taken either singly or in combination, is seen to describe the instant invention as claimed.

### SUMMARY OF THE INVENTION

The invention is a computerized multi-stage system, and method for auctioning bids on construction projects. The system utilizes Internet client-server technology. The method steps may include entering into the computerized system and validating member credentials, accessing construction projects, registering to bid on the construction projects, providing information relative to a type of contract the construction projects will have, sorting, accepting and rejecting bids for the construction projects, posting a winning bid in order for an owner to compare it to the project budget, having the winning bid be reviewed by an owner and architect of the construction projects, via a report provided by the system and providing a forum for new contractors to become members.

Accordingly, it is a principal object of the invention to provide a system and method for auctioning bids on construction projects.

It is another object of the invention to reduce construction costs on auctioned bids on construction projects.

It is another object of the invention to bid projects using a customizable, multi-stage bid-auction process.

It is another object of the invention to provide contractors with additional time between stages to evaluate their bids and to therefore reduce risk to contractor and owner.

It is another object of the invention to provide an optional pre-bid stage to determine if contractors are within a competitive range.

It is another object of the invention to enable better decision making on behalf of the owner by providing a comprehensive project report that summarizes the savings to the owner and the qualifications of the participating contractors.

It is another object of the invention to provide the owner with a system to select trade-specific contractors for the bid auction process.

It is a further object of the invention to establish new construction project bidding and evaluation standards.

Still another object of the invention is to provide a high visibility vehicle for owners and developers to auction their bids on construction projects on-line.

It is another object of the invention to raise contractor qualification standards for auctioned bids on construction projects.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a system overview for auctioning bids on construction projects according to the present invention.

FIG. 2 is a block diagram showing the participants in a system and method for auctioning bids on construction projects.

FIG. 3 represents a flowchart illustrating entry into the computerized system, password and identification validation and entry into a project room.

FIG. 4 is a flowchart illustrating how members access the viewing of construction projects, download plans and register to bid on selected projects.

FIG. 5 is a flowchart illustrating the start of the multistage bid-auction process (in this example, 3 stages are demonstrated), how the system provides information relative to the type of contract the project will have, how the first half hour of the bidding process starts and stops and how bids are sorted, accepted and rejected.

FIG. 6 is a flowchart illustrating how accepted bids are processed to post the lowest bid, how the second phase of bidding from 2:00 PM to 2:30 PM starts and stops and how again the lowest bid is posted for that stage.

FIG. 7 is a flowchart illustrating the posting of a 3:00 PM bid, submission of the best and final offer, sorting of bids and rejection of all but the lowest bid.

FIG. 8 is a flowchart illustrating the posting of the low and winning bid, comparing the winning bid to budget, with final member qualification query, owner and architect provided a comprehensive Project Report for their review, whereas the owner can then make a decision to rebid, modify the design and then re-bid the project, kill the project or decide to award the project.

FIG. 9 is a flowchart illustrating a non-member application process.

FIG. 10 is a flowchart illustrating a new applicant selecting new projects in specific states and counties and issuance of identification and password selections.

Similar reference characters denote corresponding features consistently throughout the attached drawings.

### DETAILED DESCRIPTION OF THE PREFERRED EMBODIMENT

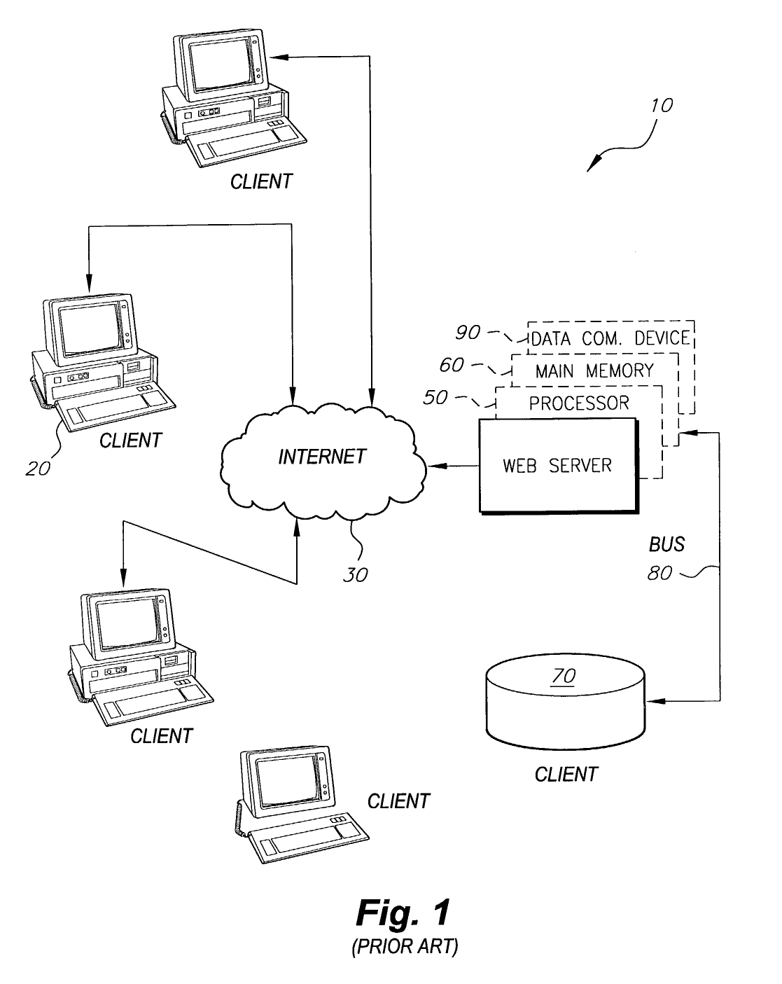

The present invention is characterized by bid-auction platform software, written in a number of different programming languages, possibly including but not limited to HTML, JAVA, JSP, PHP, ASP, VisualBasic, Javascript, and Cascading Style Sheets. The software is intended to be run off of a server, possibly configured with an open port to the Internet, allowing access to multiple clients at the same time. A representative computerized system 10 in which the present invention operates is shown in FIG. 1. The computerized system 10 uses a client-server model, including a plurality of clients 20 connected to a Web server 40 through a computer network, preferably the Internet 30, although the computerized system 10 may operate on an intranet or extranet as well. The Web server 40 has a processor 50 for processing instructions and an area of main memory 60 for executing program code under the direction of the processor 50.

The computerized system 10 also includes at least one relational database 70 for storing data. The relational database 70 may reside in an area of disk storage on the Web server 40 or may reside on a remote database server accessible by the Web server 40. The client computers 20 have a Web browser operable thereon for receiving and viewing documents written in Hypertext Markup Language (HTML) and transmitted over the Internet 30 via Hypertext Transfer Protocol (HTTP) by the Web server 40 and transmitting requests for HTML documents to the Web server 40 via HTTP.

The present invention includes software program code stored on the Web server 40 for a system and method for auctioning bids on construction projects, which is accessible to a client computer 20 through the Internet 30. The computer code may be written in JAVA (Java is a trademark of Sun Microsystems), HTML, XML or Microsoft's Active Server Pages (ASP), PHP, JAVA Server Pages (JSP), and includes code for a system and method for auctioning bids on construction projects.

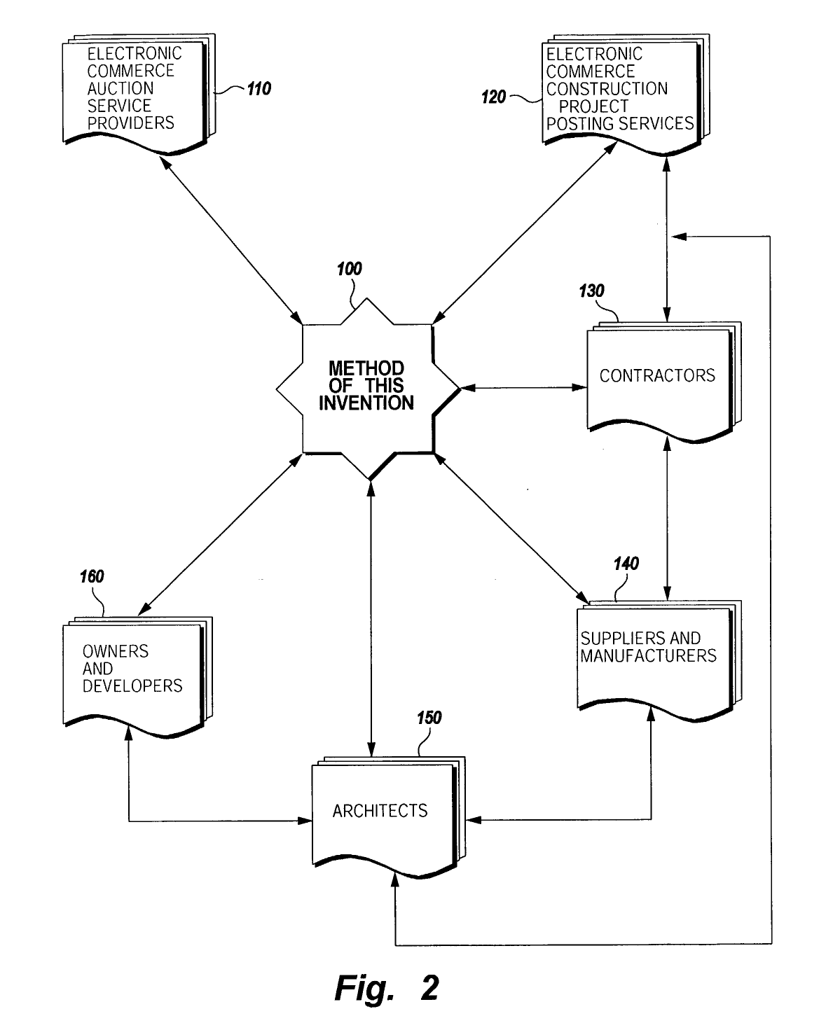

FIG. 2 illustrates the persons involved with the overall method 100 of the invention. These persons include electronic commerce auction service providers 110, electronic commerce construction project posting services 120, contractors 130, suppliers and manufacturers 140, architects 150 and owners and developers 160. Electronic commerce auction services providers 110 and electronic commerce construction project posting services 120 exist with minor modification required. These include electronic commerce auction sites similar to E-Bay and Ubid as well as electronic commerce construction project posting services similar to FWDodge.com and CDCNews.com. Contractors 130 include qualified general contractors and subcontractors nationwide and owners, and developers 160 of building construction projects. Architects 150 include architectural firms who most often manage owner and developer 160 projects, provide design services and develop plans and project specifications, while suppliers and manufacturers 140 provide materials to these contractors 130 in support of their projects.

The computer program code can be broken down into eight overall steps and includes a means for entering into the computerized system 10 and validating member credentials 170, a means for accessing the construction projects and registering to bid on the construction projects 180, a means for providing the computerized system 10 information relative to a type of contract the construction projects will have 190, a means for sorting, accepting and rejecting bids for the construction projects 200, a means for posting the low bid and comparing all competitive bids to an owner's budget 210, a means for having the low bid be reviewed by an owner 160 and architect 150 of the construction projects 220, a means for having nonmember contractors 130 applying to bid on construction projects 230 and a means for having nonmember contractors 130 selecting geographic areas of participation and issuance of identification and password selection 240. These steps are also described in detail in the subsequent figures and text.

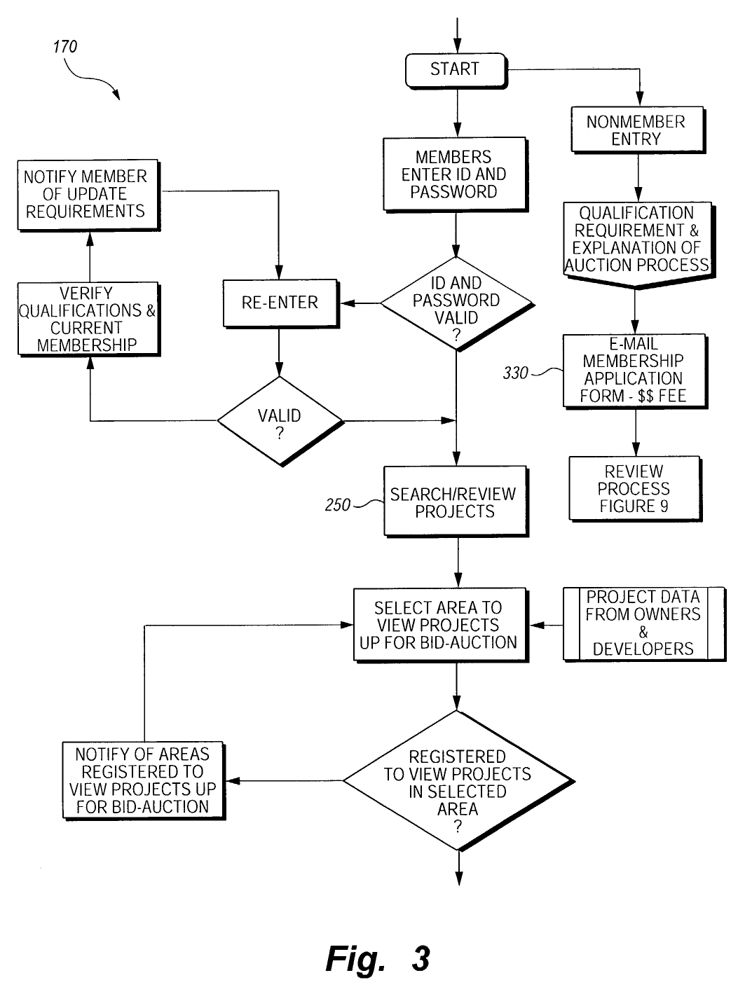

FIG. 3 is a flowchart illustrating entry into the computerized system 10, password and identification validation as well as entry into “the project room” 250. FIG. 3 depicts a means for entering into the computerized system and validating member credentials 170. Once on-line, member contractors 130 will enter their identification word and password and the computerized system 10 will check each identification word and password for validity. If invalid, the member contractor 130 will be asked to reenter his identification word and/or password, whichever is incorrect. The computerized system 10 will again check each for validity and if correct, the member contractor 130 will be authorized to proceed. If the query still shows an invalid entry, the computerized system 10 will verify qualifications and current membership and notify the member contractor 130 of update requirements and will allow the member contractor 130 to proceed once these are corrected.

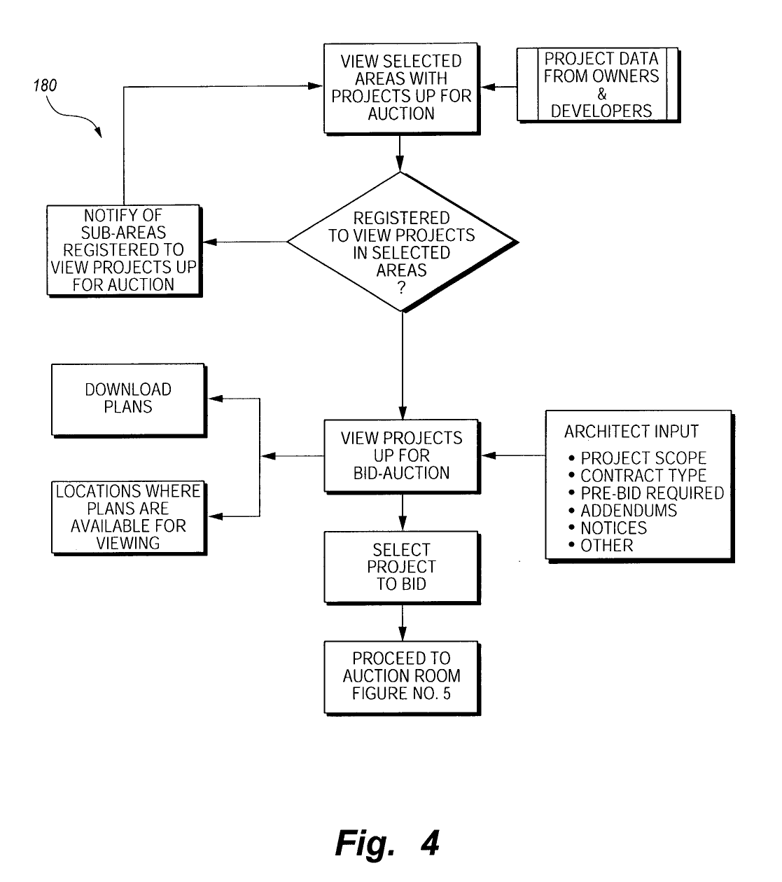

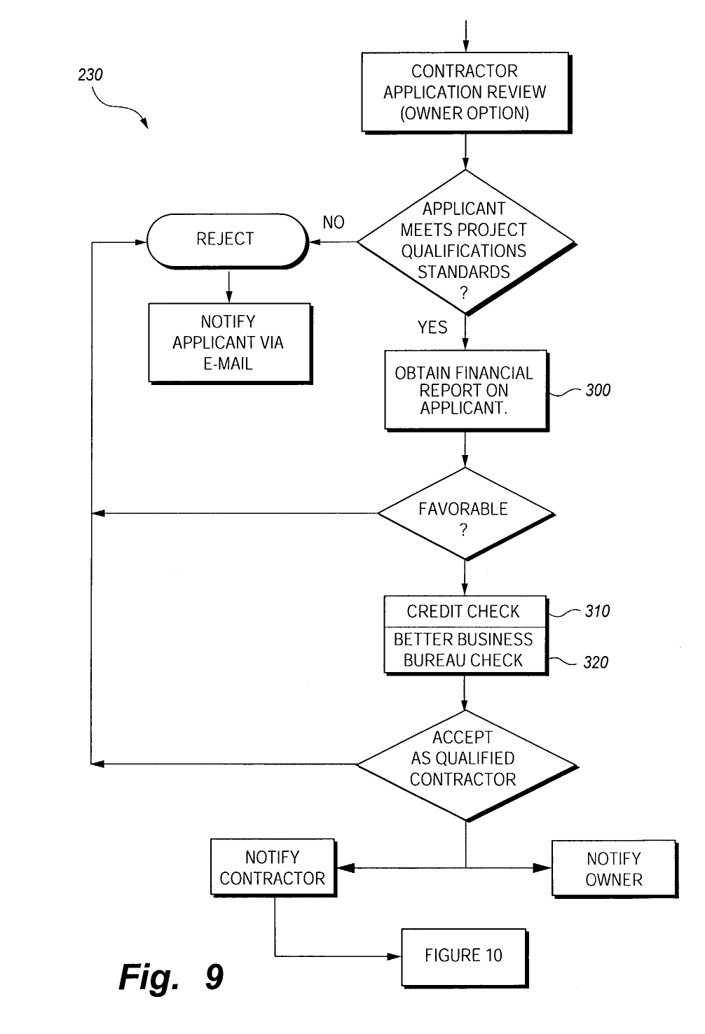

If the identification word and password were valid on the first entry, the computerized system 10 will allow him to enter the project room 250 or proceed directly to the auction room 260. In the project room 250, the member contractor 130 will select the state to view projects up for auction. Project data will be provided from owners and developers 160 throughout the geographic extent and all geographic areas will be posted for member contractor 130 selection. When an area is selected, the information will be processed to validate if the member contractor 130 is registered to view projects in a selected area. If he is not registered for the area selected, the computerized system 10 will notify him of the geographic areas he is authorized to participate in and allow him to reenter his selection. Selection of an area that the member contractor 130 is authorized to view projects up for auction will initiate viewing of sub-areas within the particular area, as is depicted in FIG. 4. The registration process for nonmember entries is also discussed in greater detail in FIG. 9.

As is shown in FIG. 4, a member contractor 130 can be registered in any number of geographic areas he so desires. FIG. 4 illustrates the means for accessing the construction projects and registering to bid on the construction projects 180. Selection of an area will also be processed for validity of registration. If the member contractor 130 is not registered for the geographic area selected, the computerized system 10 will notify him of the areas he is registered in. Correct selection of a geographic area will allow the member contractor 130 to view all of the construction projects up for auction in that particular area. Combined with owner and developer 160 project information, architect 150 input will also be provided regarding project addendums, notices and other pertinent information to the project.

While viewing the projects up for auction, the computerized system 10 will allow the member contractor 130 to download plans or find out where plans are available for viewing. At this time, the computerized system 10 will allow for the member contractor 130 to select any particular project or projects to bid on. Selection may require the member contractor 130 to register to bid on the project. This registration information would be recorded and stored for recall on the day of the auction. Once registered, the member contractor 130 can exit or proceed directly to the bid-auction room 260.

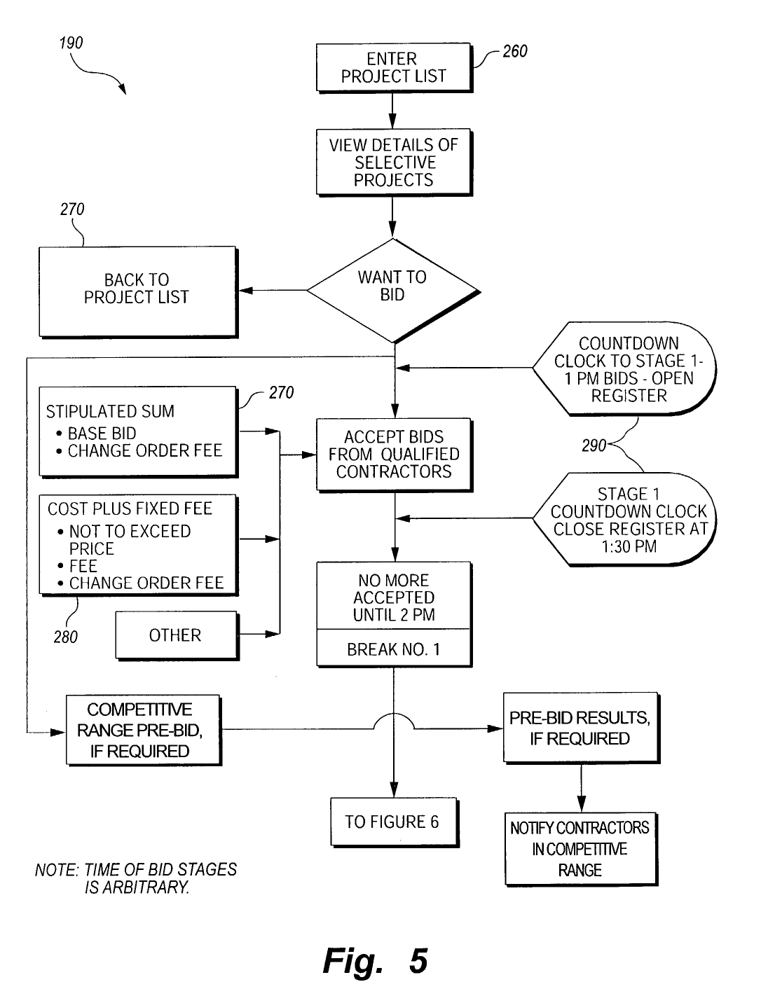

According to FIG. 5, once in the bid-auction room 260, the computerized system 10 is designed to allow for owners and developers 160, to stipulate the type of contractual vehicle they want for any particular project. As illustrated in FIG. 5, the member contractor 130 will vie for the type of contract for the project selected to be bid on. As further depicted in FIG. 5, the means for providing the computerized system 10 information relative to a type of contract the construction projects will have 190 is shown. Types of contract information may refer to stipulated sum 270, cost plus fixed fee 280 or any other type of contract desired by the owner and developer 160. The member contractor 130 will be asked if he wants to bid on the contract. If so, the contractor may be required, at the option of the owner, to participate in a single-stage pre-bid process in order to determine if he is in the owner's competitive range. This process will take place on a date and time specified by the owner. At the completion of the pre-bid process, the owner will be provided with the pre-bid results. Those within the competitive range will be allowed to participate in the following multi-stage auction process.

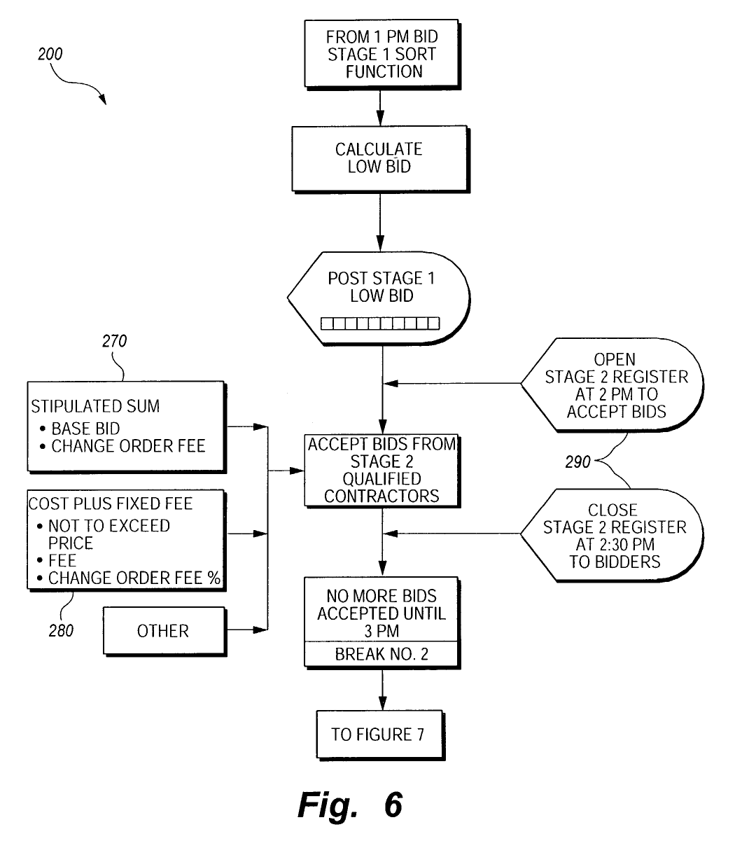

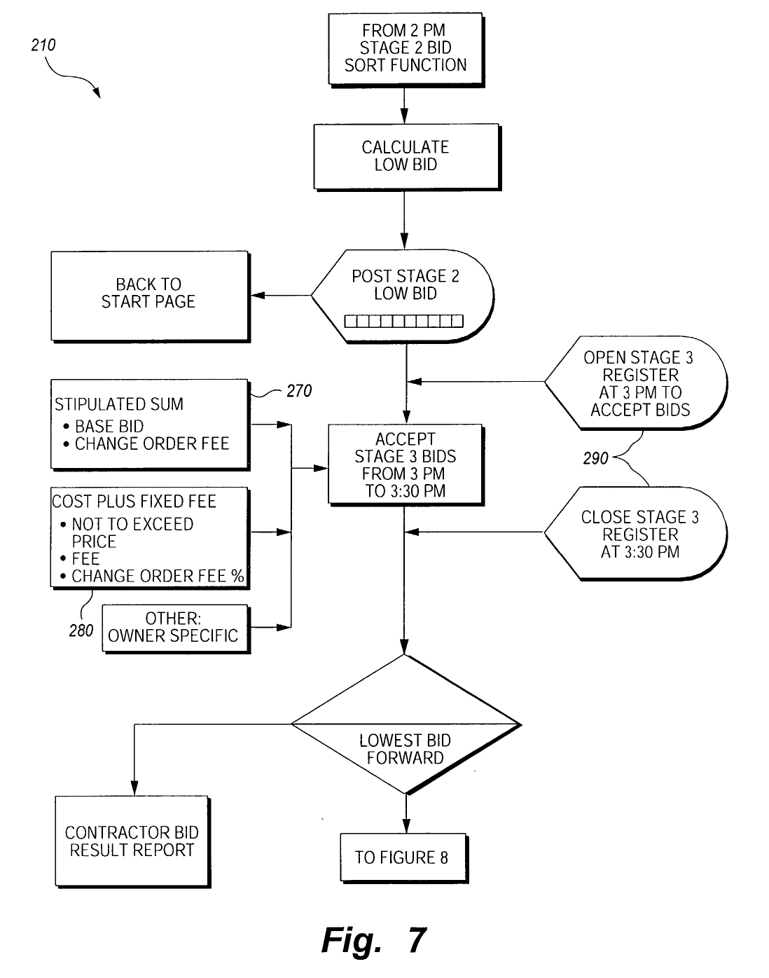

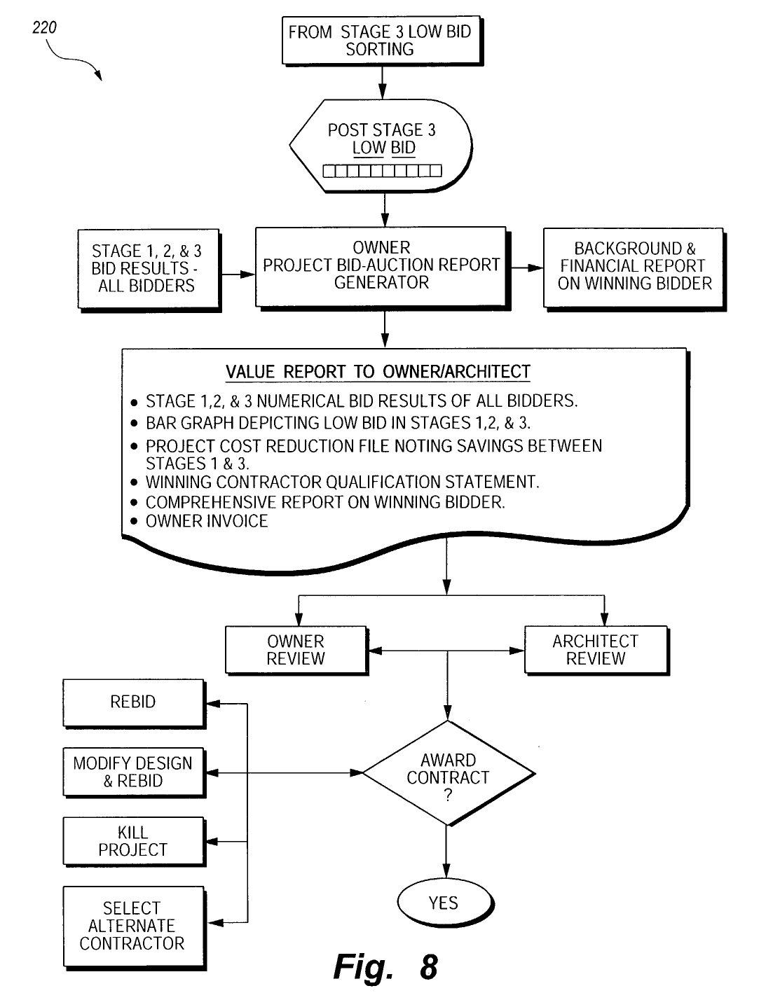

As outlined in FIG. 6, FIG. 7 and FIG. 8, there are three default time slots for bidding a project, Stage 1, 1:00 PM-1:30 PM PM, Stage 2, 2:00 PM-2:30 PM and Stage 3, 3:00 PM-3:30 PM. The time and duration parameters are fully customizable by the owner. FIG. 6 depicts the means for sorting, accepting and rejecting bids for the construction project 200. FIG. 7 depicts the means for posting the low bid and comparing all competitive bids to an owner's budget 210. FIG. 8 depicts the means for having the low bid be reviewed by an owner and a developer 160 and architect 150 for the construction project 220. The system 10 will provide a countdown clock 290 that will open registers at 1:00 PM to qualified member contractors 130 who have registered to bid on the project. For Stage 1, they will enter their bid between 1:00 PM and 1:30 PM. If this is a stipulated sum 270 type of contract, the member contractor 130 will be required to enter his base bid for the project. If it is a cost plus fixed fee 280 type of contract, the member contractor 130 will provide pricing in two fields. First will be a not to exceed price that the member contractor 130 guarantees the owner and developer 160. If the cost of the project goes over this cost, it will be at the member contractor's 130 expense. Second will be the fee the member contractor 130 will charge to complete the project.

At 1:30 PM, the Stage 1 register closes to all bids. The computerized system 10 alerts member contractors 130 that no more bids will be accepted until Stage 2 begins at 2:00 PM. Note that bids cannot be withdrawn once entered and will be rolled to the second and third slot bidding if no bid is entered during these time frames. When the 1:30 PM bidding register closes, bids are sorted and the low bid is posted.

This alerts the remaining bidders of their competitive positions in preparation for the next auction stage. At 2:00 PM the Stage 2 register opens and accepts the contractors' bids for Stage 2. Bidders again would enter their numbers in an effort to be the low-bidder of Stage 2. At 2:30 PM, the register is closed to all bidding. Bidders are notified that the next stage for bidding this project will be at 3:00 PM. With most other auctioning services, the high bid is the winner. However, this computerized system 10 is designed to select the low bidder in all instances. The low bid is posted at the end of Stage 3. The computerized system 10 then adds this number to the project report, which is available electronically to the owner and developer 160 and architect 150 for review. If the number is within budget, the member contractor's 130 qualification and membership requirements are again validated. The project report will allow the owner and developer 160 to further evaluate the bid results and the qualifications of the low-bidder. Once all issues are resolved, a decision will be made by the architect 150 and owner and developer 160 whether to award a contract, rebid the project, modify the design and then re-bid the project, or kill the project.

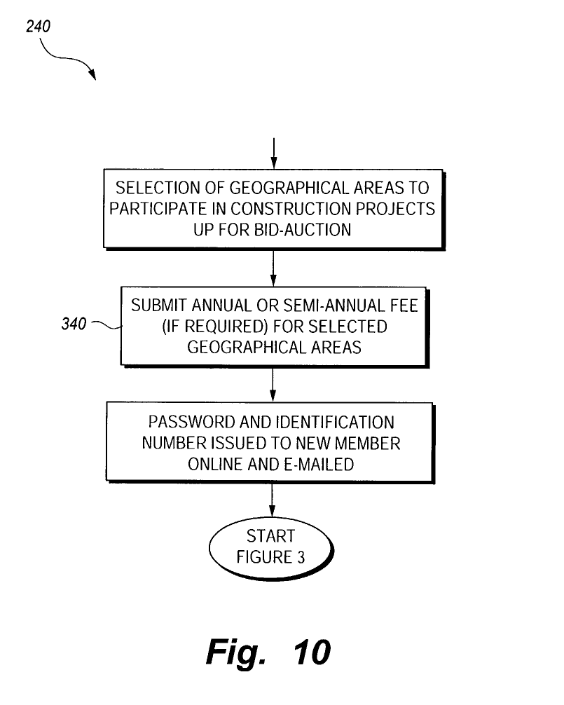

Once online, contractors who are not members and would like to join will select the nonmember entry feature originating in FIG. 3. As detailed in FIG. 9 and FIG. 10, an explanation of the qualification standard requirements, insurance requirements and auction process will be defined in detail. FIG. 9 depicts the means for having nonmember contractors 130 applying to bid on a construction project 230. FIG. 10 depicts a means for having nonmember contractors 130 selecting states and counties of participation and issuance of identification and password selection 240. If the prospective member selects to apply for membership, he will be required to complete an application form (not shown) covering AIA type qualification questions, insurance certificate requirements and other information pertinent to the application. Once submitted for review, the application will be placed on file for an owner and developer 160 to review to see if the applicant meets the required AIA qualification standards. If the participant is successful in the bidding process, a comprehensive report from Dunn and Bradstreet 300 or similar report will be added to the project report for the owner's and developer's 160 review. Once the applicant is accepted as a member, he will be required to select the states and counties he would like to participate in. Once selected, the new member may be required to submit a membership fee 330 and state/county participation fee 340. The member will then issue an identification word and password for future entry into the computerized system 10.

It is to be understood that the present invention is not limited to the sole embodiment described above, but encompasses any and all embodiments within the scope of the following claims.

We claim:

1. A computerized system for auctioning bids on construction projects, comprising:
at least one server computer having a processor, an area of main memory for executing program code under the direction of the processor, a storage device for storing data and program code, and a bus connecting the processor and the storage device;
at least one relational database stored on said storage device;
a data communications device connected to said bus for connecting said server computer to a computer network;
a Web-based multi-stage auctioning of construction project computer program code stored in said storage device and executing in said main memory under the direction of said processor, the computer program including:
means for entering into the computerized system and validating member credentials;
means for accessing the construction projects, planning locations and registering to bid on the construction projects;
means for providing information relative to a type of contract the construction projects will have;
means for providing an optional pre-bid stage to determine if contractors are within a competitive range;
means for providing a multi-stage auction process, including default posting of a low bid for every stage;
means for sorting, accepting and rejecting bids for the construction projects;
means for posting a low bid and providing a comprehensive project report to the owner and developer for their evaluation of the winning bid compared to their budget;
means for having the winning bid reviewed by an owner and developer and architect of the construction project;
means for having nonmember contractors applying for the construction projects; and
means for having nonmember contractors selecting states and counties of participation and issuance of identification and password selection.

2. The computerized system according to claim 1, wherein the member credentials include a password and an identification word.

3. The computerized system according to claim 1, wherein the construction projects are based on multiple variables, including specific counties and states of the construction projects.

4. The computerized system according to claim 1, wherein said type of contract the construction projects will have are stipulated sum, cost plus fixed fee or other specified type of contract.

5. The computerized system according to claim 1, wherein the owner and developer and architect will be given information to aid in their decision to re-bid the construction projects, modify and design and re-bid the construction projects, kill the construction projects or award the construction projects.

6. A computer program product that includes a medium readable by a processor, the medium having stored thereon a set of instructions for auctioning bids on construction projects, comprising:
a first sequence of instructions which, when executed by the processor, causes the processor to enter into a computerized system and validate member credentials;
a second sequence of instructions which, when executed by the processor, causes the processor to access the construction projects, provide availability of plans and allow for contractors to register to bid on the construction projects;
a third sequence of instructions which, when executed by the processor, causes the processor to provide information relative to a type of contract the construction projects will have;
a fourth sequence of instructions which, when executed by the processor, causes the processor to sort, accept and reject bids for the construction projects;
a fifth sequence of instructions which, when executed by the processor, causes the processor to post a low bid and provide a report to the owner so that it can be compared with an owner's budget;
a sixth sequence of instructions which, when executed by the processor, causes the processor to have the winning bid be reviewed by an owner and developer and architect of the construction projects;
a seventh sequence of instructions which, when executed by the processor, causes the processor to have nonmember contractors apply for the construction projects; and
an eighth sequence of instructions which, when executed by the processor, causes the processor to have nonmember contractors select states and counties of participation and issuance of identification and password selection.

7. A computer program product according to claim 6, wherein the member credentials are a password and an identification word.

8. A computer program product according to claim 6, wherein the construction projects are based on specific counties and states of the construction projects.

9. A computer program product according to claim 6, wherein said type of contract the construction projects will have are stipulated sum, cost plus fixed fee or other specified type of contract.

10. A computerized method for auctioning bids on construction projects over the Internet or a intranet, comprising the steps of:
entering into a computerized system and validating member credentials;
accessing the viewing of the construction projects, providing plans availability and registering to bid on the construction projects;
providing information relative to a type of contract the construction projects will have;
sorting, accepting and rejecting bids for the construction projects;
posting optional pre-bid results to determine if a contractor is within a competitive range;
posting a low bid for every stage and providing a project report for the owner and developer;
having the winning bid be reviewed by an owner and developer and architect of the construction projects;
having nonmember contractors applying for the construction projects; and
having nonmember contractors selecting geographic areas of participation and issuance of identification and password selections.

11. The computerized method according to claim 10, wherein member credentials are a password and an identification word.

12. The computerized method according to claim 10, wherein the construction projects are based on specific geographic areas of the construction projects.

13. The computerized method according to claim 10, wherein said type of contract the construction projects will have are stipulated sum, cost plus fixed fee or other specified type of contract.

14. The computerized method according to claim 10, wherein the owner and developer and architect will be provided information to aid in the decision to re-bid the construction projects, modify and design and re-bid the construction projects, kill the construction projects or award the construction projects.
